(19) United States
(12) Patent Application Publication
(10) Pub. No.: US 2013/0106023 A1
(43) Pub. Date: May 2, 2013

(54) IMPRINT APPARATUS, IMPRINT METHOD, IMPRINT SYSTEM, AND DEVICE MANUFACTURING METHOD

(71) Applicant: CANON KABUSHIKI KAISHA, Tokyo (JP)

(72) Inventors: Akiko Iimura, Utsunomiya-shi (JP); Akiyoshi Suzuki, Tokyo (JP)

(73) Assignee: CANON KABUSHIKI KAISHA, Tokyo (JP)

(21) Appl. No.: 13/658,547

(22) Filed: Oct. 23, 2012

(30) Foreign Application Priority Data
Oct. 27, 2011 (JP) 2011-236378

(51) Int. Cl. B29B 13/08

(52) U.S. Cl. 264/406; 425/169

(57) ABSTRACT

A imprint apparatus that brings a pattern formed on a mold into contact with an imprint material supplied to a substrate to transfer the pattern to the imprint material includes an emission unit configured to emit excitation light for causing a luminescent material to emit light, a detection unit configured to detect light, and a mold holding unit configured to hold the mold including the luminescent material, in which, after the pattern is transferred to the imprint material, the emission unit emits the excitation light to the pattern transferred to the imprint material, and the detection unit detects light emitted from the luminescent material remaining in the imprint material.

### BACKGROUND OF THE INVENTION

1. Field of the Invention

The present invention relates to an imprint apparatus for inspecting a mold used to transfer a pattern formed on the mold to an imprint material on a substrate.

2. Description of the Related Art

A pattern formation using an imprint technique has been performed as a technique substituted for a pattern formation method using photolithography which has been known heretofore. The imprint technique is the technique to transferring the pattern to resin by pressing a mold on which the pattern is formed against a substrate (a wafer) to which an imprint material (a resin) is supplied.

If a pattern on a mold has a defect such as damage, a pattern transferred to a resin also has the defect. For this reason, the mold needs to be inspected whether the pattern has a defect such as damage.

Japanese Patent Application Laid-Open No. 2007-296823 discusses a mold inspection method which uses a mold on the surface of which a substance including a fluorescent agent adheres. The surface of the mold is irradiated with light to observe fluorescence arising from the fluorescent agent included in the surface of the mold. The method is such that the fluorescence is observed to inspect the surface of the mold. The method discusses technique in which the surface of the mold is irradiated with excitation light to detect fluorescence, confirming the surface of the mold from the attenuation amount of fluorescent intensity before and after an imprint process.

The mold inspection method discussed in Japanese Patent Application Laid-Open No. 2007-296823 irradiates the surface of the mold with excitation light to detect fluorescence from the surface of the mold. The irradiation of the mold surface with the excitation light emits light over the whole surface of the mold. It is difficult to detect a place where light does not emit from the places when light emits over the whole surface of the mold, which may lower detection accuracy.

### SUMMARY OF THE INVENTION

An example of The present invention is directed to an imprint apparatus that detects a defect in a pattern on a mold without emitting excitation light to the surface of the mold.

According to an aspect of the present invention, an imprint apparatus that brings a pattern formed on a mold into contact with an imprint material supplied to a substrate to transfer the pattern to the imprint material includes an emission unit configured to emit excitation light for causing a luminescent material to emit light, a detection unit configured to detect light, and a mold holding unit configured to hold the mold including the luminescent material, in which, after the pattern is transferred to the imprint material, the emission unit emits the excitation light to the pattern transferred to the imprint material and the detection unit detects light emitted from the luminescent material remaining in the imprint material.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram illustrating an imprint apparatus according to a first exemplary embodiment.

FIG. 2 illustrates the detection unit of the first exemplary embodiment.

FIGS. 3A and 3B are schematic diagrams illustrating an imprint apparatus according to a second exemplary embodiment.

FIGS. 4A and 4B are schematic diagrams illustrating an imprint apparatus according to a third exemplary embodiment.

FIGS. 5A, 5B, and 5C are flow charts illustrating a process for inspecting the damage of a mold.

FIGS. 6A and 6B are block diagrams illustrating an imprint system in which a plurality of imprint apparatuses is connected.

FIG. 7 is a flow chart illustrating the inspection process of the imprint system.

FIG. 8 is a flow chart illustrating the inspection process in a case where a fluorescent agent is included in an imprint material.

### DESCRIPTION OF THE EMBODIMENTS

Various exemplary embodiments, features, and aspects of the invention will be described in detail below with reference to the drawings.

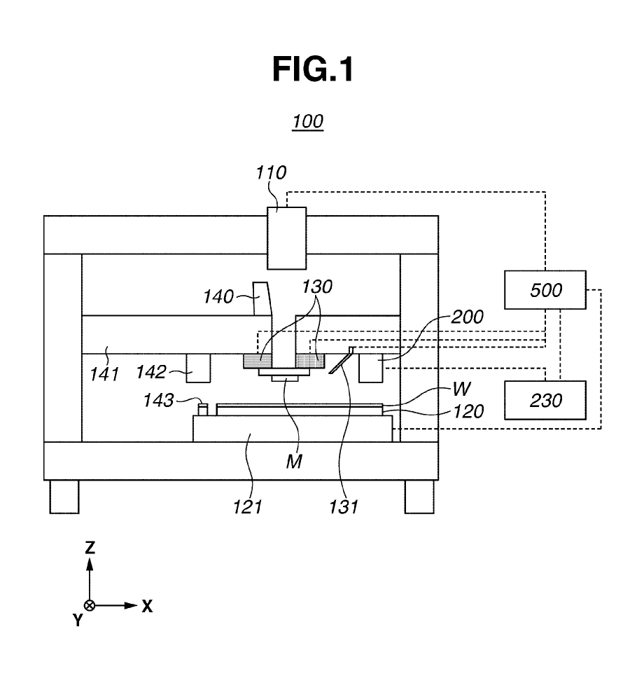

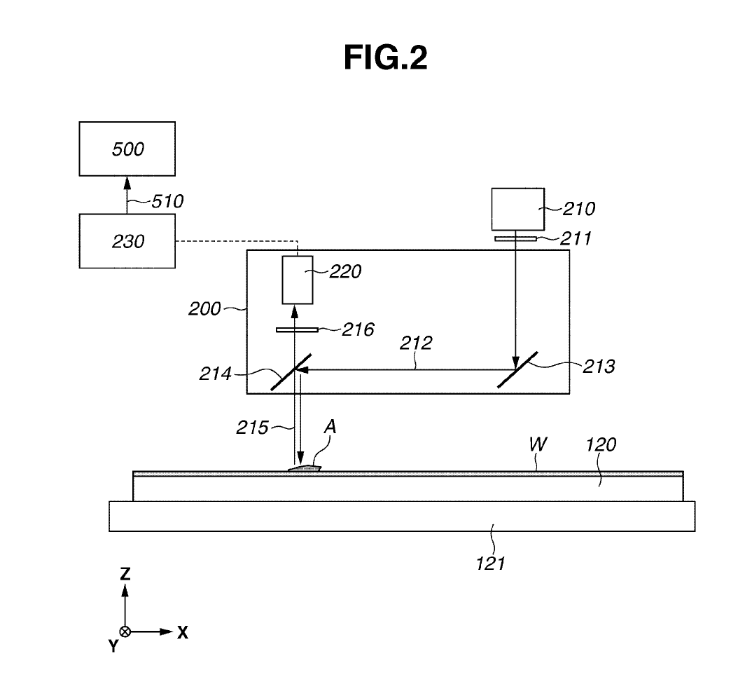

A first exemplary embodiment will be described. An imprint apparatus according to the first exemplary embodiment of the present invention is described below with reference to FIGS. 1 and 2. FIG. 1 is a schematic diagram illustrating an imprint apparatus 100 according to the first exemplary embodiment of the present invention. As illustrated in FIG. 1, each axis is determined with the height direction of the imprint apparatus 100 being taken as Z direction and the plane where a substrate W is arranged being taken as XY plane.

The imprint apparatus 100 includes a light source 110, a substrate holding unit 120, a mold holding unit 130, an alignment scope 140, and a detection unit 200. The imprint apparatus 100 further includes a supply unit 131 for supplying resin as an imprint material to the surface of a substrate W. The supply unit 131 includes a tank for storing resin therein and a nozzle which is connected with the tank and drips the resin onto the substrate.

The light source 110 emits light (curing light) for curing an imprint material supplied to the substrate. In general, since resin cured by irradiation with ultraviolet rays is used as the imprint material, ultraviolet rays are emitted from the light source 110. The imprint material is cured with the pattern formed on a mold M brought into contact with the imprint material to allow the pattern to be transferred to the imprint material.

The substrate holding unit 120 is a chuck mechanism for holding the substrate W (a wafer). The substrate W can be held by a vacuum chuck, for example. The substrate holding unit 120 is held by a stage 121. The stage 121 moves on the XY plane of the imprint apparatus 100 to allow the substrate W to move to a desired position.

The mold holding unit 130 includes a chuck mechanism for holding the mold M on which an uneven pattern is formed. The mold holding unit 130 further includes a driving unit for moving the mold M in the direction of the Z axis. The mold M moves downward in the Z axis to imprint a pattern formed on the mold M onto the resin. The mold M moves upward in the Z axis to allow the mold M to be released from the resin. Furthermore, the mold holding unit 130 may be provided with a function to control the orientation of the mold M and a function to perform alignment in the rotation direction so that the pattern surface formed on the mold M is brought into close contact with the substrate W.

The alignment scope 140 observes a mark formed on the substrate W and a mark formed on the mold M. An alignment between the mold M and the substrate W is performed by using observation results which are obtained with the alignment scope 140. An automatic adjustment scope (AAS) may be used as the alignment scope 140.

An off-axis scope (OAS) 142 for observing, without via the mold M, a mark formed on the substrate W is provided as another alignment mechanism. The off-axis scope 142 detects a reference mark 143 formed on the stage 121. The alignment scope 140 and the off-axis scope 142 are provided on the frame 141.

The detection unit 200 detects light emitted from a luminescent material adhering to the surface of the substrate W. The present exemplary embodiment uses the mold M including a fluorescent agent (a luminescent material). If the mold M is damaged, a part of the mold M adheres onto the substrate W. The emission of light to the surface of the substrate W causes the fluorescent agent to emit light, so that the damage of the mold M is inspected by detecting the light. Thus, fluorescence on the surface of the substrate W is observed and fluorescence of the fluorescent agent included in the mold is detected to detect the damage of the mold M.

If the mold is irradiated with excitation light to detect fluorescence, thereby detecting the damage of the mold M, a place where light is not emitted or the amount of light is small needs to be identified while light is emitted substantially over the whole surface of the mold M. If light emitted from a substance is detected, it is advantageous in terms of detection that others lying around the substance do not emit light rather than emit light. For this reason, rather than irradiating the mold with excitation light, irradiating the surface of the substrate on which a pattern is transferred with excitation light to detect fluorescence allows the damage of pattern of the mold to be easily detected.

Data such as luminous intensity detected by the detection unit are sent to a processing unit 230 and the luminous intensity is compared with a reference value. The imprint apparatus 100 includes a control unit 500 which controls the operation of the imprint apparatus 100.

FIG. 2 illustrates the detection unit 200. An emission unit 210 includes a light emitting element which emits excitation light 212 being light exciting the fluorescent agent included in the mold M. The excitation light 212 is guided to the surface of the substrate W by a mirror 213 and a half mirror 214. A light receiving unit 220 receives fluorescence 215 emitted from the fluorescent agent included in a fragment A of the mold M remaining in the substrate W. A filter 211 may be arranged to acquire a specific wavelength as the excitation light 212.

A filter 216 may be arranged in the front of the light receiving unit 220 to select the wavelength of the fluorescence 215 emitted from the luminescent material included in the fragment A of the mold M. A band-pass filter, a high-pass filter, or low-pass filter may be used as the filter 216. Alternatively, a combination of the above filters may be used.

Use of the half mirror 214 in the detection unit 200 allows the excitation light 212 and the fluorescence 215 to be separated. Data of fluorescent intensity received by the light receiving unit 220 are sent to the processing unit 230. The processing unit 230 compares the fluorescent intensity received by the light receiving unit 220 with the reference value to determine whether the mold M is damaged. If it is determined that the mold M having the fluorescent agent is damaged, a signal 510 for stopping the operation of the imprint apparatus 100 is transmitted to the control unit 500. Thus, the operation of the imprint apparatus 100 can be stopped if the mold M is damaged.

In FIG. 2, the emission unit 210 is separated from the detection unit 200, however, the emission unit 210 may be included in the detection unit 200. The light emitting element included in the emission unit 210 is not limited in particular if the light emitting element emits light including light with wavelength which causes the fluorescent agent to emit. For example, a mercury-xenon lamp or a halogen lamp may be used. The emission unit 210 acting as a light source (a light emitting element) for exciting the excitation light 212 is arranged separately from the light source 110 (a resin curing light source) for curing the resin on the substrate, however, the emission unit 210 may be used as the light source 110. This will be described in detail below in the present exemplary embodiment.

The fluorescent agent according to an aspect of the present invention will be described in detail below. The fluorescent agent according to an aspect of the present invention can be used without problem provided that the fluorescent agent is a substance that emits the fluorescence 215 by being irradiated with the excitation light 212. However, it is useful that the excitation light 212 and the fluorescence 215 are different in wavelength from ultraviolet light for curing the resin and the fluorescent agent has resistance to the ultraviolet light.

For instance, acridine-based fluorescent material, anthracene-based fluorescent material, rhodamine-based fluorescent material, pyrromethene-based fluorescent material, and perylene-based fluorescent material are cited as examples. Advantageously, 3,6-dimethylaminoacridine (Acridine Orange) and 2,6-di-t-butyl-8-nonyl-1,3,5,7-tetramethylpyrromethene-BF₂complex (PYROMETHENE 597-8C9) are cited as examples. Furthermore, N,N′-bis(2,6-dimethylphenyl)perylene-3,4,9,10-tetracarboxy diimido and rhodamine 6G (RHODAMINE 590) are cited as examples.

It is useful that the fluorescent agent included in the mold M is not transferred to the substrate in the imprint process. Specifically, the fluorescent agent is chemically bonded with the mold M or mixed with a material forming the mold M instead of being physically absorbed to the surface of the mold M. If the mold M is produced by resin including the fluorescent agent, it is advantageous that the fluorescent agent has dispersibility to the resin. Fluorescence may be extinguished depending on mixed quantity, so that the mixed quantity is appropriately adjusted to acquire fluorescent intensity. As resin for producing the mold M, F-template (produced by Asahi Glass Co., Ltd) being fluororesin molding material may be used. The mold M is produced by mixing and dispersing the fluorescent agent with and into the material. A dispersing agent may be properly added to improve the dispersibility of the fluorescent agent.

If the mold M is made of quartz, it is advantageous to chemically bond a substance having a fluorescent portion to a hydroxyl group on the surface of quartz as a method for including the fluorescent agent in the mold M.

It is advantageous that the fluorescent agent for chemically bonding to a hydroxyl group on the surface of quartz is a substance having a fluorescent portion and a silyl group. For instance, N-(triethoxysilylpropyl)dansylamide and o-4-methylcoumarinyl-N-[3-(triethoxysilyl)propyl]carbamate are cited as examples. The fluorescent agent having a hydroxyl group may be used by being mixed with a releasing agent chemically bonded with the hydroxyl group of the surface of quartz. The releasing agent may have an alkylfluoridesilyl group, for example. For instance, heptadecafluoro-1,1,2,2-tetrahydrodecyl-1-triethoxysilane is cited as an example. The fluorescent agent(s) may be used solely or in combination of two or more.

Thus, the fluorescent agent is not transferred to the resin at the time of a normal imprinting and the fluorescent agent remains on the resin when the mold M is damaged. Fluorescence on the substrate on which a pattern is transferred is detected to allow the defect of the pattern to be detected. Since fluorescence on the substrate is detected to detect the defect of the pattern, even if an inspection apparatus is different from an imprint apparatus, inspection can be performed without detaching the mold from the mold holding unit. In Japanese Patent Application Laid-Open No. 2007-296823, the fluorescent intensity of surface of the mold M is measured each time transfer is performed a certain number of times, so that an imprinting operation needs to be stopped irrespective that a defect occurs. In an example of the present invention, on the other hand, inspection can be conducted without stopping the imprinting operation of the imprint apparatus while the inspection is performed.

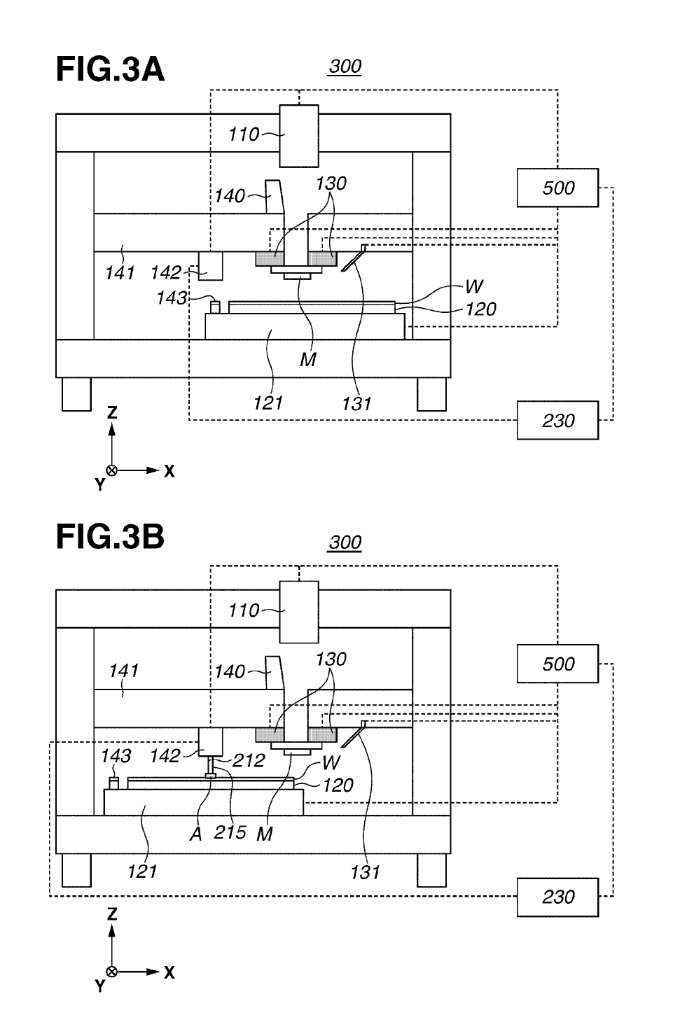

A second exemplary embodiment will be described. An imprint apparatus according to the second exemplary embodiment of the present invention is described below with reference to FIGS. 3A and 3B. FIGS. 3A and 3B illustrate an imprint apparatus 300 according to the second exemplary embodiment of the present invention. The first exemplary embodiment describes the imprint apparatus provided with a dedicated detection unit for inspecting the defect of the mold. The present exemplary embodiment describes an imprint apparatus 300 provided with an alignment detection system serving also as a detection unit for inspecting defects.

FIG. 3A illustrates that an off-axis scope 142 detects a reference mark 143. FIG. 3B illustrates that an off-axis scope 142 detects the fluorescence 215 by irradiating the fragment A remaining in the imprint material with the excitation light 212. The same reference numerals and characters as those in the imprint apparatus 100 according to the first exemplary embodiment described in FIG. 1 are not described.

The off-axis scope 142 used in the imprint apparatus according to the present exemplary embodiment may have a magnification switching function. The off-axis scope 142 may detect a mark on the substrate W and fluorescence for inspecting a defect by using the magnification switching function.

As is the case with the imprint apparatus illustrated in FIGS. 3A and 3B, the detection unit 200 illustrated in FIG. 2 may serve also as the alignment detection system. In this case, as illustrated in FIG. 3B, the stage 121 is moved to an inspection position to observe fluorescence using the off-axis scope 142.

The light source of the off-axis scope 142 may be used as that of the excitation light 212, or the light source 110 for curing the resin may be used.

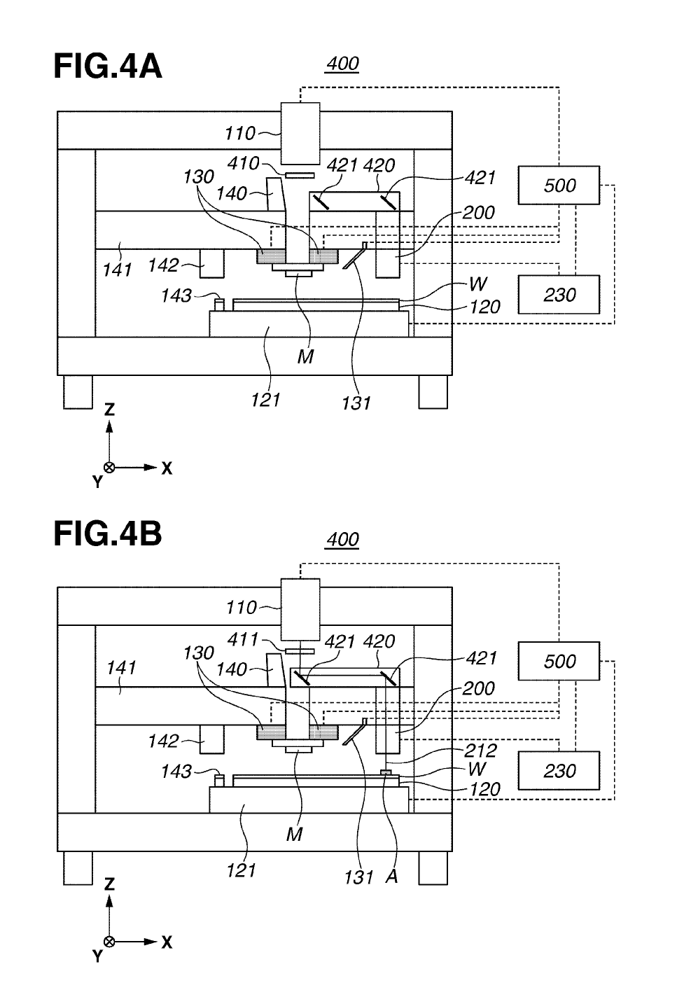

A third exemplary embodiment will be described. An imprint apparatus according to the third exemplary embodiment of the present invention is described below with reference to FIGS. 4A and 4B. FIGS. 4A and 4B illustrate an imprint apparatus 400 according to the third exemplary embodiment of the present invention. In the first exemplary embodiment, the emission unit 210 for emitting the excitation light 212 is arranged separately from the light source 110 for emitting light for curing the resin on the substrate. In the present exemplary embodiment, the imprint apparatus will be described in which the light source 110 serves also as the emission unit 210.

The imprint apparatus 400 is provided with a light guiding unit 420 for guiding light from the light source 110 to the detection unit 200 for inspecting the damage of the mold. Switching an optical path allows the light source 110 to be used for imprint operation and inspection of damage of the mold.

FIG. 4A illustrates a case where the light source 110 is used to perform the imprint operation. FIG. 4B illustrates that the fragment A remaining in the imprint material is irradiated with the excitation light 212 using the light source 110. The light guiding unit 420 includes a mirror 421. The mirrors 421 are arranged in a retracting position illustrated in FIG. 4A to allow the light source 110 to be used for curing the resin on the substrate W. The excitation light 212 needs to be guided to the detection unit 200 to inspect the damage of the mold. More specifically, the mirrors 421 of the light guiding unit 420 are arranged in an inspection position illustrated in FIG. 4B to enable the excitation light 212 to be guided to the detection unit 200.

A filter 410 (in FIG. 4A) for cutting ultraviolet rays acquired from the light source 110 excluding those having a specific wavelength may be provided to use only the wavelength for curing the resin. Alternatively, a filter 411 (in FIG. 4B) may be provided to use only the wavelength of the excitation light 212. A driving unit (not illustrated) is provided to switch the arrangement of the mirrors 421 of the light guiding unit 420, thereby the filters 410 and 420 may be switched.

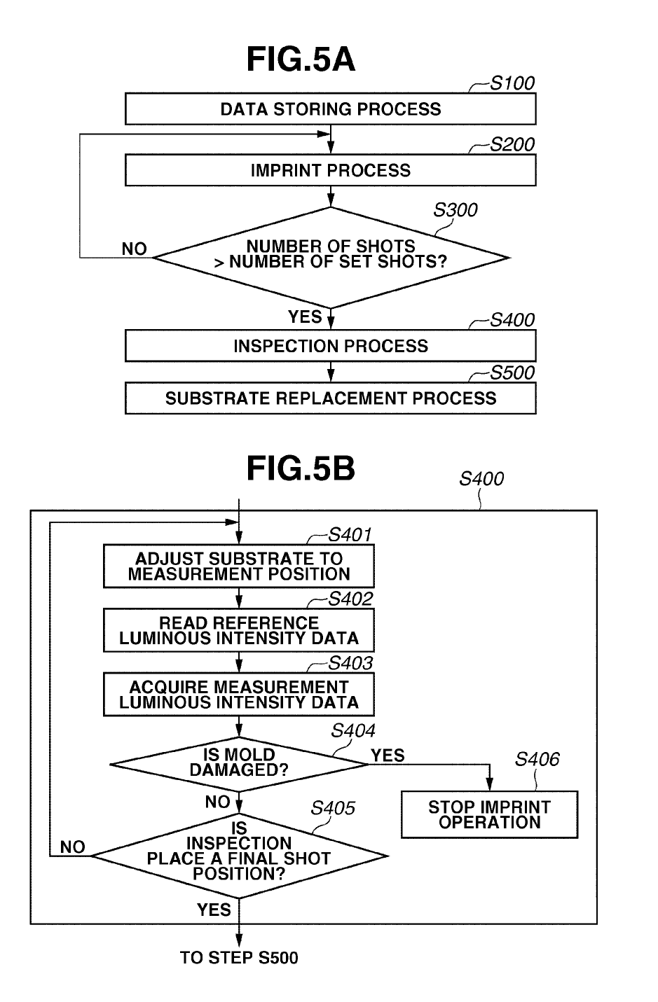

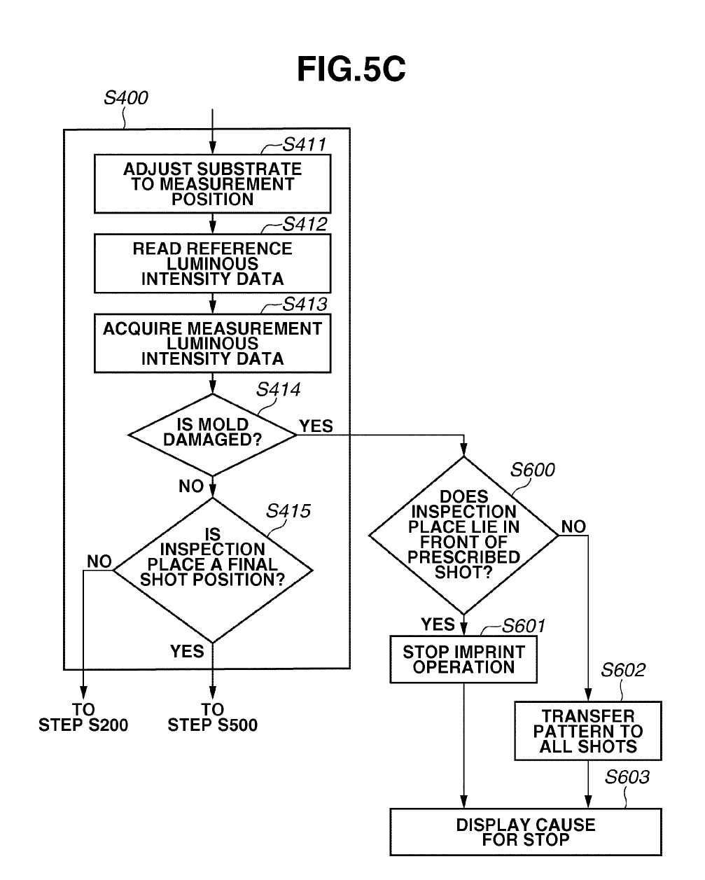

A method for inspecting the damage of the mold M will be described in detail below with reference to FIG. 5A. The method may use any of the imprint apparatuses described in the above exemplary embodiments. The inspection method includes a data storage process in step S100, an imprint process in step S200, an inspection execution determination process in step S300, an inspection process in step S400, and a substrate replacement process in step S500.

In step S100, which is the data storage process, the imprint apparatus stores a reference luminous intensity (reference detection result) of the substrate W previously measured as a reference in the processing unit 230 of the imprint apparatus according to an example of the present invention. A substrate which does not include the fragment A of the mold W in the surface of the substrate is used as the reference substrate W.

The imprint process in step S200 will be described below. The imprint process is the one that transfers the pattern formed on the mold M to the imprint material supplied to the substrate W.

The substrate W to which the pattern is transferred is placed on the substrate holding unit 120 by a substrate conveyance system (not illustrated). The substrate holding unit 120 holds the substrate W by vacuum suction. An alignment mark formed on the substrate is detected using the off-axis scope 142 to measure the position of the substrate W. Each transfer coordinate (shot position) is acquired from the measurement results. Sequential transfer (step and repeat) is performed based on the results.

The control unit 500 controls the light source 110, the stage 121, the mold holding unit 130, and the supply unit 131 to transfer the pattern. Specifically, the supply unit 131 supplies the imprint material in moderate quantities to the transfer position of surface of the substrate W. Thereafter, the stage 121 moves the substrate W to the transfer position to perform alignment. After completion of the alignment, the mold holding unit 130 lowers the mold M to bring the pattern formed on the mold M into contact with the imprint material on the substrate. After the pattern is filled with the imprint material, the resin is irradiated with curing light to cure the resin. After the resin is cured, the mold is lifted (released). The substrate W is moved to the next transfer position. This is repeated to allow the pattern to be transferred to the substrate W.

In step S300, which is the inspection execution determination process, the imprint apparatus determines whether the number of shots in which patterns are transferred exceeds the number of previously set shots. Until the number of set shots is exceeded, in step S200, which is the imprint process, the imprint apparatus transfers patterns. If the number of set shots is exceeded (YES in step S300), the imprint apparatus can inspect the substrate W. If the substrate W is inspected at all shots on the substrate, the inspection execution determination process in step S300 may be omitted. If the number of set shots is greater than the number of shots of a single substrate W, the imprint process in step S200 includes a replacement work for the substrate W. The substrate W is replaced such that the substrate W in which the transfer of patterns is completed is carried out from the substrate holding unit 120 by a substrate conveyance system (not illustrated) and a new substrate W is carried in.

In step S400, which is the inspection process, the imprint apparatus inspects whether the mold M is damaged.

In step S500, which is the substrate replacement process, the substrate W in which the transfer of patterns is completed is carried out from the substrate holding unit 120 by the substrate conveyance system (not illustrated).

The inspection process in step S400 will be described in detail below with reference to the flow chart of FIG. 5B. In the following description, a pattern is assumed as being transferred to all shots on the substrate in the imprint process. In step S401, the stage 121 moves to adjust the substrate to the measurement position. If fluorescence is detected by the detection unit 200 as the first and the third exemplary embodiment do, the measurement position underlies the detection unit 200. If fluorescence is detected by the off-axis scope 142 as the second exemplary embodiment does, the measurement position underlies the off-axis scope 142.

In step S402, the reference luminous intensity (reference detection result) stored in step S100 is read. In step S403, the substrate to be measured is irradiated with the excitation light 212 to acquire a measurement luminous intensity (detection result) of the fluorescence 215. At this point, position coordinate of the measured shot may be acquired.

In step S404, it is determined whether the mold is damaged. Determination is made by the processing unit 230 of the imprint apparatus. The determination is made such that the reference luminous intensity is compared with the measurement luminous intensity and, if the measurement luminous intensity is greater than the reference luminous intensity, it is determined that the mold is damaged. If the fragment A of the mold exists, fluorescence whose intensity exceeds the reference is observed. If the reference luminous intensity is zero, it is determined that the mold is damaged whenever measurement luminous intensity is detected. Alternatively, determination can be made based only on a numeric value of the measurement luminous intensity. If the measurement luminous intensity does not exceed the reference, it is determined that the mold is not damaged.

If it is determined that the mold is not damaged (NO in step S404), in step S405, the processing proceeds to an inspection end determination process. If an inspection place is a final shot position (YES in step S405), the inspection of all shots on the substrate is regarded as being ended and the processing proceeds to a substrate replacement process. If the inspection of all shots is not ended (NO in step S405), the shot to be inspected next is adjusted to the measurement position in step S401.

If it is determined that the mold is damaged (YES in step S404), in step S406, the processing unit 230 transmits the signal 510 for stopping the imprint operation to the control unit 500 of the imprint apparatus. Thus, by stopping the imprint operation performed using the damaged mold, continuing to produce a defective product can be stopped. After the imprint operation is stopped, the damaged mold is replaced and a new imprint operation is started.

If the off-axis scope 142 is taken as the detection unit like the imprint apparatus according to the second exemplary embodiment, before the substrate is adjusted to the measurement position in step S401, the magnification and the filter of the detection unit are switched to those for position measurement. Before the substrate is irradiated with the excitation light 212 in step S403, a process for switching the magnification and the filter of the detection unit to those for the inspection is added.

If the light source 110 is taken as the light source of the excitation light 212 like the imprint apparatus according to the third exemplary embodiment, an process is added in which the filter of the light source is switched and the mirror 421 of the light conducting unit 420 is adjusted to the inspection position at least before the substrate is irradiated with the excitation light 212 in step S403.

The inspection process in step S400 will be described in detail below with reference to the flow chart in FIG. 5C. FIG. 5C describes a case where an inspection is performed as to whether the mold is damaged for each imprint process of each shot. Steps S411 to S413 correspond to the above steps S401 to S403, so that description thereof is omitted. Differences from the above inspection method 1 are described below.

If it is determined that the mold is damaged (YES in step S414), in step S600, a process for determining whether the imprint operation is stopped is added. A method for determining whether the mold is damaged is similar to that of the above step S404.

In step S600, it is determined whether a place of inspection whether the mold is damaged lies in front of a prescribed shot. If the place is in front of the prescribed shot (YES in step S600), the processing proceeds to a process for transmitting an imprint operation stop signal in step S601. If the place is not in front of the prescribed shot (NO in step S600), the processing proceeds to a process for transferring patterns to all shots in step S602. The position of the prescribed shot for determining whether imprint is stopped or continued needs to be previously determined in consideration of yielding. A process of Step S603 may be added after steps S601 and S602. In step S603, it is indicated that the imprint operation is stopped due to the damage of the mold.

If the imprint operation is stopped in the course of the shot on the substrate, all chips on the substrate become defective products. For this reason, if a shot position where the damage of the mold is detected is near to the final shot position, the imprint process is repeated to improve a yield even after the damage of the mold is detected. This is because a shot in which a pattern is transferred before the damage of the mold is detected does not become defective. The process for determining whether the imprint operation is stopped is effective in terms of improvement of a yield.

If it is determined that the mold is not damaged (NO in step S414), the processing proceeds to an inspection end determination process in step S415. If an inspection place is the final shot position (YES in step S415), the inspection of all shots on the substrate is regarded as being ended and the processing proceeds to the substrate replacement process in step S500. If the transfer of patterns to all shots is not ended (NO in step S415), the processing proceeds to the imprint process in step S200 to transfer a patter to the next shot.

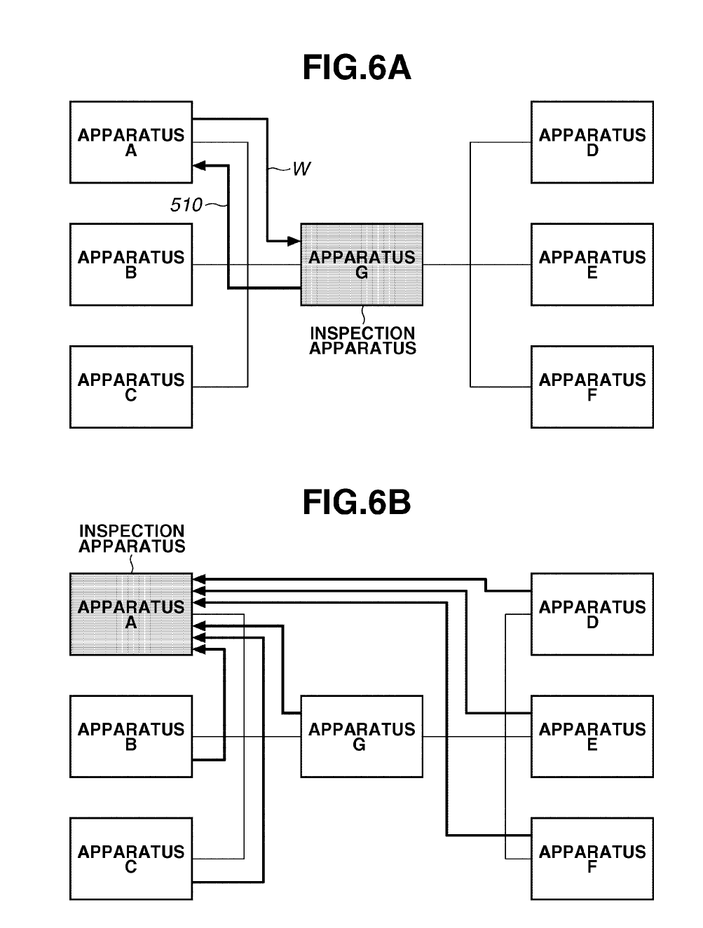

An imprint system in which a plurality of imprint apparatuses is connected to each other will be described below with reference to FIG. 6A. By connecting a plurality of imprint apparatuses, mutual facilities can be shared. In FIG. 6A, an example is described in which one of imprint apparatuses A to G is shared as a damage inspection apparatus for the mold.

The imprint apparatuses A to F produce substrate W on which the pattern of the mold is transferred and the imprint apparatus G used as an inspection apparatus inspects the substrate W. In the imprint system in which a plurality of imprint apparatuses is connected to each other and mutual facilities are shared, all imprint apparatuses include detection units 200 for detecting the damage of the mold.

Apparatuses for performing the imprint operation whose number do not exceed an inspection processing capacity of the apparatus for performing a mold damage inspection can be connected with one apparatus for performing a mold damage inspection. Six apparatuses for transferring patterns are connected therewith.

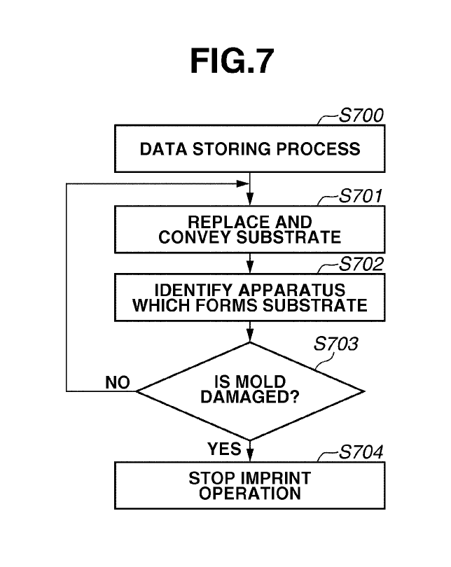

As illustrated in FIG. 6A, the substrate W on which a pattern is transferred by the apparatus A is sent to the apparatus G and the apparatus G performs the mold damage inspection. The apparatus G performs inspection according to a flowchart in FIG. 7. In a data storage process in step S700, the reference luminous intensity of the substrate serving as the reference is previously stored before the substrate W is sent to the apparatus G. Thereafter, in step S701, which is a process of substrate replacement and conveyance, the substrate W is conveyed in the apparatus G.

In step S702, which is a process for identifying an apparatus forming a substrate, the apparatus forming the substrate W is identified. The substrate has a serial number. By reading the serial number with the apparatus G, the imprint apparatus forming the substrate can be identified. Thus, it is identified that the substrate W to be inspected by the apparatus G is produced by the apparatus A.

In step S703, which is an inspection process, it is determined whether the mold is damaged. The inspection process described in step S400 may be used as a measurement method. If the acquired luminous intensity exceeds the reference luminous intensity, it is determined that the mold is damaged. If it is determined that the mold is damaged (YES in step S703), in step S704, the signal 510 for stopping the imprint operation is transmitted to the apparatus A.

In the above description, the apparatus G serves as the imprint apparatus, however, the apparatus G may serve as a dedicated inspection apparatus. In that case, an inspection apparatus including the inspection unit 200 described in FIG. 2 is used.

After the imprint operation of the apparatus A is stopped, the damaged mold is removed from the apparatus A and washed and maintained. During that period, the apparatus A cannot produce the substrate, however, may be used as an inspection apparatus.

A case where the inspection is performed by the apparatus A stopping the imprint operation will be described below with reference to FIG. 6B. The apparatuses B to G produce the substrate W on which a pattern is transferred and the apparatus A performs inspection. The apparatus G used as the inspection apparatus in FIG. 6A is used as an apparatus for forming a pattern. The substrate W is conveyed to the apparatus A and the inspection is performed according to the flow chart illustrated in FIG. 7 as described above. Thus, the imprint system in which a plurality of the imprint apparatuses including the detection units is connected (clustered) and shares mutual facilities can also perform inspection for the damage of the mold in the course of the maintenance of the apparatus.

Apparatuses to be thus clustered may use any imprint apparatus described in the above exemplary embodiments. The imprint system in which a plurality of the imprint apparatuses is connected can avoid forming the substrate using a damaged mold and maintain the number of the apparatuses for transferring patterns, thereby allowing the number of formed substrates which is reduced during the maintenance to be minimized.

A defect in a pattern is detected by detecting fluorescence on the substrate, so that the imprint apparatus can continue the imprint operation even while the inspection apparatus is performing the inspection of the substrate. This can improve productivity.

The mold needs to be removed from the imprint apparatus to inspect the mold in order to detect the defect of a pattern. In general, removing the mold from the apparatus is a time-consuming work, so that it is not useful to remove the mold of which damage is not yet confirmed from the imprint apparatus. Furthermore, when the mold of which damage is not detected is attached again, it is not always true that the mold M is held with the mold holding unit 130 in the same position as where the inspection has been performed. For that reason, since the position of the mold needs to be detected every time the mold of which inspection is ended is attached, productivity may be lowered.

In the above, a case is described in which imprint is performed using the mold including the fluorescent agent.

A case will be described below in which, in the imprint method using the mold including the fluorescent agent with a fluorescent wavelength P, an imprint material including the fluorescent agent with a fluorescent wavelength Q different from the fluorescent wavelength P of the fluorescent agent included in the mold is used. When the fluorescence on the substrate on which the pattern is transferred is observed in such a method, if the mold is damaged to leave the fragment A on the substrate, the fluorescent wavelength P of the fluorescent agent included in the mold is observed. Defect caused by change in the thickness of the imprint material is observed as change in the intensity of the fluorescent wavelength Q. If change in the fluorescent intensity of the fluorescent wavelength Q of the imprint material is confirmed, it is proved that a defect resulting from the imprint material is caused. Even if a defect resulting from the imprint material is detected, the imprint operation can be stopped similarly with the case where the damage of the mold is detected.

An emission unit includes a light source for emitting excitation light (a first excitation light) for causing a fluorescent agent (a first luminescent material) included in a mold to emit light and a light source for emitting excitation light (a second excitation light) for causing a fluorescent agent (a second luminescent material) included in an imprint material to emit light. The light source can be selected according to an object to be inspected. If the light source including excitation wavelengths for causing the first and the second luminescent material to emit light is used, the wavelength of light to be transmitted may be selected by switching a filter.

Any of the methods described in FIGS. 5A to 5C may be used as the inspection method. The inspection process may be performed every time the setting number of shots is exceeded or the inspection process may be performed for each shot. In the inspection process in step S400, if the intensity of the fluorescent wavelength P of the fluorescent agent included in the mold exceeds the reference value, it is determined that the mold is damaged, and the imprint operation of the imprint apparatus is stopped. Similarly, if the intensity of the fluorescent wavelength Q of the fluorescent agent included in the imprint material exceeds the reference value, it is determined that a defect resulting from the imprint material occurs, and the imprint operation of the imprint apparatus is stopped. Substrates yet to be inspected are retrospectively inspected as to whether the fluorescent wavelength P exists to be able to confirm whether the mold is damaged.

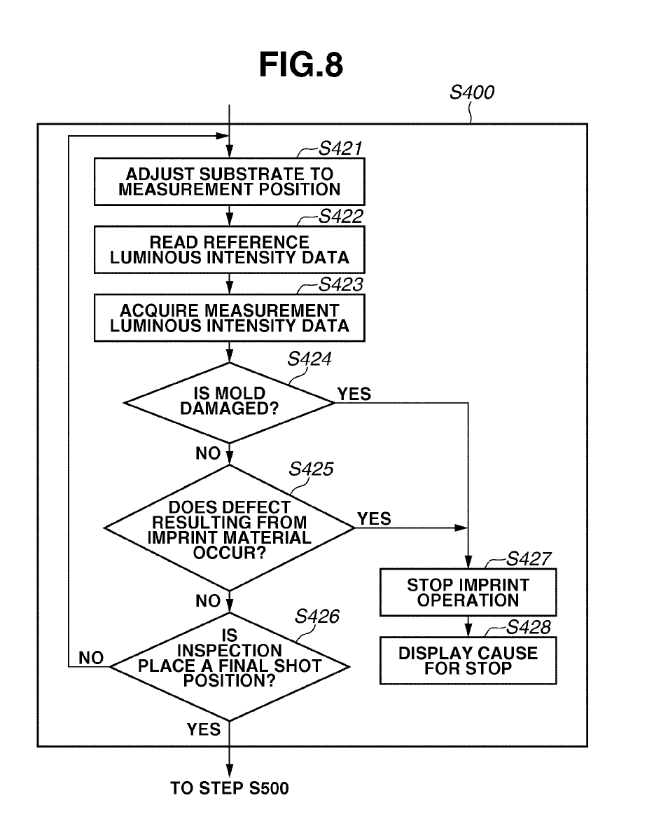

As illustrated in a flowchart of FIG. 8, for example, in step S424, after it is determined whether the mold is damaged, in step S425, it is determined whether a defect resulting from the imprint material occurs. In step S427, if the imprint operation is stopped based on any of the determination results, in step S428, cause for the stop of the imprint operation may be displayed. Steps S421 to S423 correspond to steps S401 to S403 in FIG. 5B. Step S426 corresponds to step S405 in FIG. 5B.

The light receiving unit in the detection unit may be provided with a function to receive light separating the fluorescent wavelength P of the mold and the fluorescent wavelength Q of the imprint material. When the light source including the first and the second excitation light is used as excitation light, by separating each luminous wavelength to perform detection, the fluorescent wavelength intensity of the mold and that of the imprint material can be detected at the same time.

This enables easily classifying whether the defect results from the damage of the mold or from the imprint material such as a defective plug.

The first exemplary example will be described. In the present exemplary example, the mold M was formed of quartz and the surface thereof was processed by o-4-methylcoumarinyl-N-[3-(triethoxysilyl)propyl]carbamate. The excitation wavelength of o-4-methylcoumarinyl-N-[3-(triethoxysilyl)propyl]carbamate is 340 nm. The fluorescent wavelength thereof is 500 nm. The mold M was installed on the imprint apparatus 100 illustrated in FIG. 1 and the imprint operation was repeated to transfer the pattern to the imprint material supplied to the substrate. The excitation light 212 guided to the detection unit 200 was acquired by using the filter 211 transmitting light of 340 nm. By using a filter transmitting light of 500 nm as the filter 216, the light receiving unit 220 is allowed to detect the fluorescence 215. Inspection was performed according to the flow charts illustrated in FIGS. 5A to 5C. If fluorescent intensity exceeding the reference is detected in the inspection process, it is determined that the mold is damaged. The processing unit 230 transmits the signal 510 for stopping the imprint operation to the control unit 500 to stop the imprint operation.

The second exemplary example will be described. In the present exemplary example, the mold M was formed of quartz and the surface thereof was processed by o-4-methylcoumarinyl-N-[3-(triethoxysilyl)propyl]carbamate. The excitation wavelength of o-4-methylcoumarinyl-N-[3-(triethoxysilyl)propyl]carbamate is 340 nm. The fluorescent wavelength thereof is 500 nm. The mold M was installed on the imprint apparatus 400 illustrated in FIG. 4A and the imprint operation was repeated to transfer the pattern to the imprint material supplied to the substrate. The curing light for curing the imprint material was acquired by using the filter 410 transmitting light of 313 nm. When the inspection is performed, the filter 411 is arranged as illustrated in FIG. 4B, the light guiding unit 420 is switched to inspection position. The exciting light 212 was acquired by using the filter 411 transmitting light of 340 nm. Inspection is performed according to the flow charts illustrated in FIGS. 5A to 5C. If fluorescent intensity exceeding the reference is detected in the inspection process, it is determined that the mold is damaged. The processing unit 230 transmits the signal 510 for stopping the imprint operation to the control unit 500 to stop the imprint operation.

The third exemplary example will be described. In the present exemplary example, the mold M whose region where a pattern is formed is formed of resin is installed on the imprint apparatus 100 and the pattern is transferred to the imprint material supplied to the substrate. The mold M includes rhodamine 6G (RHODAMINE 590) used as a fluorescent agent. The excitation wavelength of rhodamine 6G is 530 nm and the fluorescent wavelength thereof is 560 nm. The curing light for curing the imprint material was acquired by using the filter 410 transmitting light of 313 nm. The filter 411 transmitting light of 530 nm was used to acquire the excitation light 212. Inspection is performed according to the flow charts illustrated in FIGS. 5A to 5C. If fluorescent intensity exceeding the reference is detected in the inspection process, it is determined that the mold is damaged. The processing unit 230 transmits the signal 510 for stopping the imprint operation to the control unit 500 to stop the imprint operation.

A fourth exemplary example will be described below. The present exemplary example uses fluorescent agents different in a fluorescent wavelength for the imprint material and the mold to detect a defect resulting from the imprint material and the damage of the mold once.

In the imprint apparatus according to the first exemplary example, the imprint material with which the rhodamine 6G (RHODAMINE 590) is mixed was supplied to the substrate and a pattern was transferred thereto. The exciting light 212 for the fluorescent agent included in the imprint material was acquired by using the filter 211 transmitting light of 530 nm for the light emitted from a mercury xenon lamp light source included in the emission unit 210. The exciting light 212 for the fluorescent agent included in the mold was acquired by using the filter 211 transmitting light of 340 nm for the light emitted from the mercury xenon lamp light source included in the emission unit 210. These excitation lights 212 were guided to the detection unit 200 at the same time, separated into fluorescent wavelengths of 560 nm and 500 nm and detected by the light receiving unit 220 of the detection unit 200.

Inspection was performed according to the flow chart illustrated in FIGS. 5A to 5C. The substrate exceeding previously set shots of 3000 was inspected. A luminous intensity of 560 nm being a luminous wavelength of the fluorescent agent included in the imprint material exceeding the reference value was detected in the inspection process. The processing unit 230 transmits the signal 510 for stopping the imprint operation to the control unit 500 to stop the imprint operation.

As a result of inspecting a substrate yet to be inspected and to have produced earlier than the substrate in which a defect resulting from the imprint material was detected, a luminous intensity of 500 nm being a luminous wavelength of the fluorescent agent included in the mold exceeding the reference value was detected, so that the mold was determined as being damaged. This enables easily classifying causes for the defect by using the fluorescent agents different in a fluorescent wavelength for the imprint material and the mold, even if a defect resulting from the mold and the imprint material is not observed at the same place.

A method for manufacturing devices (a semiconductor integrated circuit device and a liquid crystal display device) includes a process for transferring (forming) a pattern on a substrate (a wafer, glass plate, and film substrate) using the above-described imprint apparatus. The method for manufacturing devices may include a process for etching the substrate on which the pattern is transferred.

If other articles such as a pattered medium (recording medium) or an optical device are produced, the above method may include processes other than the etching for processing the substrate on which the pattern is transferred. The method for manufacturing articles is more advantageous in at least one of the performance, quality, productivity, and production cost of the article than a conventional method.

The exemplary embodiments of the present invention are described above. The present invention is not limited to the exemplary embodiments and various modification and changes can be made without deviating the gist of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-236378 filed Oct. 27, 2011, which is hereby incorporated by reference herein in its entirety.

What is claimed is:

1. An imprint apparatus that brings a pattern formed on a mold into contact with an imprint material supplied to a substrate to transfer the pattern to the imprint material, the imprint apparatus comprising:
an emission unit configured to emit excitation light for causing a luminescent material to emit light;
a detection unit configured to detect light; and
a mold holding unit configured to hold the mold including the luminescent material; wherein, after the pattern is transferred to the imprint material, the emission unit emits the excitation light to the pattern transferred to the imprint material, and the detection unit detects light emitted from the luminescent material remaining in the imprint material.

2. The imprint apparatus according to claim 1, wherein the emission unit emits light for curing the imprint material with the mold bought into contact with the imprint material.

3. The imprint apparatus according to claim 1, wherein the detection unit detects a mark formed to align the substrate.

4. The imprint apparatus according to claim 1, wherein a defect of the mold is detected by comparing a detection result detected by the detection unit when the emission unit emits the exciting light to the pattern transferred to the imprint material, and a reference detection result detected by the detection unit when the mold has no defect and the emission unit emits the exciting light to the pattern transferred to the imprint material.

5. The imprint apparatus according to claim 1, wherein, if the detection unit detects the defect of the mold by detecting light emitted from the luminescent material remaining in the imprint material, the transfer of the pattern is stopped.

6. An imprint apparatus that brings a pattern formed on a mold into contact with an imprint material supplied to a substrate to transfer the pattern to the imprint material, the imprint apparatus comprising:
an emission unit configured to emit first excitation light for causing a first luminescent material to emit light and second excitation light for causing a second luminescent material to emit light;
a detection unit configured to detect light emitted from the first luminescent material and light emitted from the second luminescent material; and
a mold holding unit configured to hold the mold including the first luminescent material;
wherein, after the pattern is transferred to the imprint material including the second luminescent material, the emission unit emits the first exciting light to the pattern transferred to the imprint material, the detection unit detects the defect of the mold by detecting light emitted from the first luminescent material, and the emission unit emits the second exciting light to the pattern transferred to the imprint material, the detection unit detects the defect of the pattern transferred to the imprint material by detecting light emitted from the second luminescent material.

7. An imprint method that brings a pattern formed on a mold including a luminescent material into contact with an imprint material supplied to a substrate to transfer the pattern to the imprint material, the imprint method comprising:
emitting, after the pattern is transferred to the imprint material, excitation light for causing the luminescent material to emit light to the pattern transferred to the imprint material; and
detecting light emitted from the luminescent material remaining in the imprint material.

8. An imprint system that connects a plurality of imprint apparatuses which bring a pattern formed on a mold including a luminescent material into contact with an imprint material supplied to a substrate to transfer the pattern to the imprint material with an inspection apparatus to allow mutual facilities to be shared, wherein the inspection apparatus includes:
an emission unit configured to emit excitation light for causing a luminescent material to emit light; and
a detection unit configured to detect light; wherein, after the substrate in which the pattern is transferred to the imprint material by the imprint apparatus is carried in, the emission unit emits the excitation light to the pattern transferred to the imprint material, and the detection unit detects light emitted from the luminescent material remaining in the imprint material.

9. An imprint system that connects a plurality of imprint apparatuses according to claim 1 to allow mutual facilities to be shared, wherein, if any of the plurality of imprint apparatuses detects the defect of the mold by the detection unit detecting light emitted from the luminescent material remaining in the imprint material, the imprint apparatus detecting the defect of the mold emits the excitation light to the pattern on which the pattern is transferred by other plurality of imprint apparatuses, and the detection unit detects light emitted from the luminescent material remaining in the imprint material.

10. An imprint system that connects a plurality of imprint apparatuses according to claim 6 to allow mutual facilities to be shared, wherein, if any of the plurality of imprint apparatuses detects the defect of the mold by the detection unit detecting light emitted from the first luminescent material remaining in the imprint material, the imprint apparatus detecting the defect of the mold emits the excitation light to the pattern on which the pattern is transferred by other plurality of imprint apparatuses, and the detection unit detects light emitted from the first luminescent material remaining in the imprint material and the second luminescent material.

11. A device manufacturing method comprising:
forming a pattern on a substrate using the imprint apparatus according to claim 1; and
processing the substrate on which the pattern is formed by the forming.
